(19) United States
(12) Patent Application Publication
(10) Pub. No.: US 2025/0367070 A1
(43) Pub. Date: Dec. 4, 2025

(54) HEAD-UP APPARATUS FOR CARDIOPULMONARY RESUSCITATION AND METHOD FOR CONTROLLING SAME

(71) Applicant: SEOUL NATIONAL UNIVERSITY HOSPITAL, Seoul (KR)

(72) Inventors: Dongkeon LEE, Seongnam-si (KR); Daekon KIM, Seongnam-si (KR)

(21) Appl. No.: 19/148,401

(22) PCT Filed: Jan. 9, 2024
(86) PCT No.: PCT/KR2024/000405

§ 371 Date: Aug. 12, 2025

(30) Foreign Application Priority Data
Jan. 18, 2023 (KR) 10-2023-0007181

(51) Int. Cl. A61H 31/00; A61G 13/02; A61G 13/12

(52) U.S. Cl. CPC A61H 31/008; A61G 13/02; A61G 13/1215; A61G 2200/327

(57) ABSTRACT

Disclosed is a head-up apparatus for cardiopulmonary resuscitation. The apparatus supports a user's head during cardiopulmonary resuscitation, and in particular, is configured to open the airway and blood vessels during cardiopulmonary resuscitation by tilting the user's head horizontally to prevent the neck from bending while positioning the user's head higher than the heart to increase cerebral perfusion pressure and cerebral blood flow.

### TECHNOLOGY FIELD

The present invention relates to a head-up apparatus for cardiopulmonary resuscitation and a method for controlling the same. The apparatus supports a user's head during cardiopulmonary resuscitation, and in particular, is configured to open the airway and blood vessels of the user during cardiopulmonary resuscitation by tilting a user's head horizontally to prevent the neck from bending while positioning the user's head higher than the heart to increase cerebral perfusion pressure and cerebral blood flow.

### CROSS-REFERENCE TO RELATED APPLICATION

This application claims priority to Korean Patent Application No. 10-2023-0007181, filed on Jan. 18, 2023, the disclosure of which is incorporated herein by reference.

### BACKGROUND ART

A standard chest compression position for cardiopulmonary resuscitation, which is a supine position, is generally used. The chest compression in the supine position for cardiopulmonary resuscitation increases the blood volume and pressure in the arterial system and the right side of the heart, which are transmitted to the brain through the jugular vein and paravertebral venous plexus. The increased blood volume and pressure increase intracranial pressure and decrease cerebral perfusion.

The intracranial pressure is generally high in patients in the supine position. A head-up position is generally used in a non-invasive manner to reduce intracranial pressure in patients with traumatic brain injury.

The head-up cardiopulmonary resuscitation increases venous reflux from the brain to the heart by gravity, reduces intracranial pressure, and improves cardiac preload. In addition, several recent studies have shown that the head-up cardiopulmonary resuscitation increases cerebral perfusion pressure and cerebral blood flow by reducing intracranial perfusion.

### PRIOR ART DOCUMENT

### Patent Literature

Korean Patent No. 10-1808670 (Dec. 13, 2017)

### DETAILED DESCRIPTION OF THE INVENTION

### Technical Solution

In one aspect, the present invention aims to solve the problems of the prior art as described above. An object of the present invention is to provide a head-up apparatus for cardiopulmonary resuscitation and a method for controlling the same, wherein the head-up apparatus stably supports a user's head to prevent the head from shaking during cardiopulmonary resuscitation and tilts the user's head horizontally to open the airway and blood vessels of the user while positioning the user's head higher than the heart to increase cerebral perfusion pressure and cerebral blood flow during cardiopulmonary resuscitation, thereby improving the neurological prognosis of the user.

In another aspect, an object of the present invention is to provide a head-up apparatus for cardiopulmonary resuscitation, which enables the user to take a stable head-up position and measures a real time cerebral blood flow of the user to provide precise first aid, and a method for controlling the same.

### SUMMARY OF THE INVENTION

A head-up apparatus, according to the present invention for achieving the above-described objects, includes a head cover having a groove to accommodate a head of a user, an operation unit that supports the head cover, moves the head cover in an up-down direction, and tilts the tilted head cover horizontally, a driving unit that drives the operation unit to move the head cover in the up-down direction, and a locking unit that locks the head cover horizontally.

In addition, according to a preferred embodiment of the present invention, a cushion unit is fixed inside the groove.

In addition, according to a preferred embodiment of the present invention, the groove is formed on an upper surface of the head cover, and protrusions in contact with jaws of the user are formed on edges of the groove and covered by the cushion unit.

In addition, according to a preferred embodiment of the present invention, the head cover has a downwardly open structure with a sidewall formed downward from the upper edge of the head cover, and the operating unit is located on the inside of the sidewall of the head cover and is fixed to a base plate located below the head cover.

In addition, according to a preferred embodiment of the present invention, the driving unit expands and contracts in a longitudinal direction thereof, and the operation unit is connected to the driving unit to move the head cover in the up-down direction according to the expansion and contraction of the driving unit.

In addition, according to a preferred embodiment of the present invention, the operation unit includes an upper frame including a horizontal surface to which the head cover is fixed and a vertical surface bent downward from the horizontal surface, a vertical frame located on a side of the vertical surface of the upper frame and connected thereto by a tilting shaft so as to be relatively rotatable, a base plate located below the head cover, and a link unit having one end hinged to the base plate and the other end hinged to the vertical frame, and connected to the driving unit so as to move the vertical frame and the upper frame upward or downward in accordance with expansion and contraction of the driving unit.

In addition, according to a preferred embodiment of the present invention, wherein a pair of link units face each other with the driving unit interposed therebetween, where two link assemblies are arranged symmetrically and include a first link having one end connected to the base plate by a first hinge and pivoting in the up-down direction, and a second link having one end connected to the other end of the first link by a second hinge and the other end connected to the vertical frame by a third hinge.

In addition, according to a preferred embodiment of the present invention, a connecting bar fixed to both ends of the driving unit is fixed, and the second hinge connecting the first link to the second link is mounted on both ends of the connecting bar.

In addition, according to a preferred embodiment of the present invention, a gear unit is formed at one end of the first link to be engaged with a gear unit of another first link, the gear units positioned symmetrically with each other. A gear unit is formed at the other end of the second link to be engaged with a gear unit of another second link, the gear units positioned symmetrically with each other.

In addition, according to a preferred embodiment of the present invention, the upper frame includes a stopper, and the stopper interferes with the second link as the upper frame is tilted, thereby limiting the tilt of the upper frame.

In addition, according to a preferred embodiment of the present invention, the link interfering with the stopper is provided with a guide for guiding the movement direction of the stopper according to a change in tilt of the upper frame.

In addition, according to a preferred embodiment of the present invention, the locking unit includes a locking bolt penetrating the vertical frame and the vertical surface of the upper frame, a nut fixed to one of the vertical frame and the vertical surface of the upper frame and screwed with the locking bolt, a locking flange formed in the middle of the length of the locking bolt and configured to increase friction between the vertical frame and the vertical surface of the upper frame by pressing the other of the vertical frame and the vertical surface of the upper frame by rotation of the locking bolt to limit the tilting of the upper frame, and a handle fixed to an end of the locking bolt.

In addition, according to a preferred embodiment of the present invention, a curved long hole is formed on the other of the vertical surface of the upper frame and the vertical frame pressed by the locking flange, wherein the curved long hole enables the tilting of the upper frame and the locking bolt penetrates the curved long hole.

In addition, according to a preferred embodiment of the present invention, a display unit indicating a tilting angle of the upper frame or a height of the head cover is mounted on an outer surface of the head cover, a guide piece extending to the outside of the head cover and facing the display unit is fixed to the vertical frame, and a point of the display unit moving according to a vertical movement or a tilting angle of the head cover is indicated by the guide of the guide piece.

In addition, according to a preferred embodiment of the present invention, the head-up apparatus further comprises a band bracket mounted on the upper frame and extending outward of the head cover, wherein a band mounted on the band bracket surrounds and fixes the user's head located in the groove of the head cover.

In addition, according to a preferred embodiment of the present invention, the band bracket on which the band is mounted is fixed to one side of the base plate so that the band surrounds the shoulder of the user.

In addition, according to a preferred embodiment of the present invention, the base plate includes a power supply unit that supplies power necessary for the operation of the driving unit.

In addition, according to a preferred embodiment of the present invention, the head cover is symmetrically split into a left head cover and a right head cover, wherein the left head cover and the right head cover are movable so as to be further away or closer to come into contact with each other.

In addition, according to a preferred embodiment of the present invention, the operation unit includes a sliding rail connecting the left head cover to the right head cover and arranged to enable the left head cover and the right head cover to slide freely in a left-right direction, an actuator that is connected to the left head cover and the right head cover and moves the left head cover and the right head cover so as to be further away or closer to come into contact with each other, an upper frame that includes a horizontal surface on which the sliding rail is mounted and a vertical surface bent downward from the horizontal surface, a vertical frame that is located on a side of the vertical surface of the upper frame and is connected thereto by a tilting shaft to be relatively rotatable, a base plate that is located below the head cover, and a link unit that is hinged to one end of the base plate and hinged to the other end of the vertical frame and is connected to the driving unit to move the vertical frame and the upper frame upward or downward according to expansion and contraction of the driving unit.

In addition, according to a preferred embodiment of the present invention, the actuator is a motor cylinder.

In addition, according to a preferred embodiment of the present invention, the actuator includes a left screw block fixed to one of the left head cover and the right head cover, a right screw block fixed to the other of the left head cover and the right head cover, and a bolt having a left screw formed on one side and a right screw formed on the other side, the bolt being fastened to the left screw block and the right screw block and moving the left screw block or the right screw block so as to further away or closer to be in contact with each other depending on the rotation.

In addition, according to a preferred embodiment of the present invention, the driving unit is a motor cylinder.

In addition, according to a preferred embodiment of the present invention, the apparatus may further include a cerebral blood flow measuring device, such as a near-infrared spectroscopy device, for measuring, e.g., in real time, the cerebral blood flow of the user according to the height of the user's head. In addition, the driving unit may be controlled based on a cerebral blood flow of the cerebral blood flow measuring device.

In addition, the method of controlling the head-up apparatus according to the present invention includes driving the driving unit while the head of the user is seated on the groove, moving the head cover upward while the operation unit moves the head cover upward by driving the driving unit so that a front end of the head cover is tilted to be positioned higher than a rear end of the head cover, tilting the head cover horizontally to open the airway and blood vessels of the user, and tilting and locking the head cover while the head cover is tilted horizontally.

### Effect of the Invention

As described above, the head-up apparatus for cardiopulmonary resuscitation, according to the present invention, can increase cerebral perfusion pressure and cerebral blood flow as the user's head is positioned higher than the heart during cardiopulmonary resuscitation. In this state, the head cover is tilted horizontally from the top of the head to the chin of the user to open the airway or blood vessels of the user, thereby improving the neurological prognosis of the user and preventing suffocation.

In addition, it is possible to stably fix the user's head with a band to prevent the head from shaking during cardiopulmonary resuscitation.

### BRIEF DESCRIPTION OF THE DRAWINGS

FIG. 1 is a perspective view of a head-up apparatus for cardiopulmonary resuscitation according to the invention.

FIG. 2 is a plan view of the head-up apparatus shown in FIG. 1.

FIG. 3 is a cross-sectional view of the head-up apparatus taken along line A-A′ shown in FIG. 2.

FIG. 4 is a perspective view of an operation unit when a head cover is removed from the head-up apparatus shown in FIG. 1.

FIG. 5 is an exploded perspective view of the operation unit shown in FIG. 4.

FIG. 6 is a front view of the head-up apparatus when a user's head is raised.

FIG. 7 is a front view of the operation unit of the head-up apparatus shown in FIG. 6.

FIG. 8 is a front view of the head-up apparatus when the head cover is tilted from the state of FIG. 6.

FIG. 9 is a front view of the operation unit of the head-up apparatus in the state of FIG. 8.

FIG. 10 is a schematic view of a cerebral blood flow measuring device attached to the back of the head.

### BEST MODE FOR IMPLEMENTING THE INVENTION

A user herein refers to a person using a head-up apparatus for cardiopulmonary resuscitation. In one embodiment, the user may be a patient subject to cardiopulmonary resuscitation and may be understood to encompass subjects participating in the test or the experiment, subjects practicing cardiopulmonary resuscitation using the present apparatus, and the like. That is, the user defined herein includes a subject, a trainee, a patient, or the like who is lying head-up with the face facing upward by using the head-up apparatus for cardiopulmonary resuscitation. Thus, the user is not particularly limited as long as it is a subject to which the head-up apparatus for cardiopulmonary resuscitation can be applied. Hereinafter, a person who is lying head-up with the face facing upward by the present apparatus is collectively referred to as a “user.” A preferred embodiment of the head-up apparatus for cardiopulmonary resuscitation according to the invention is described in detail below with reference to the accompanying drawings.

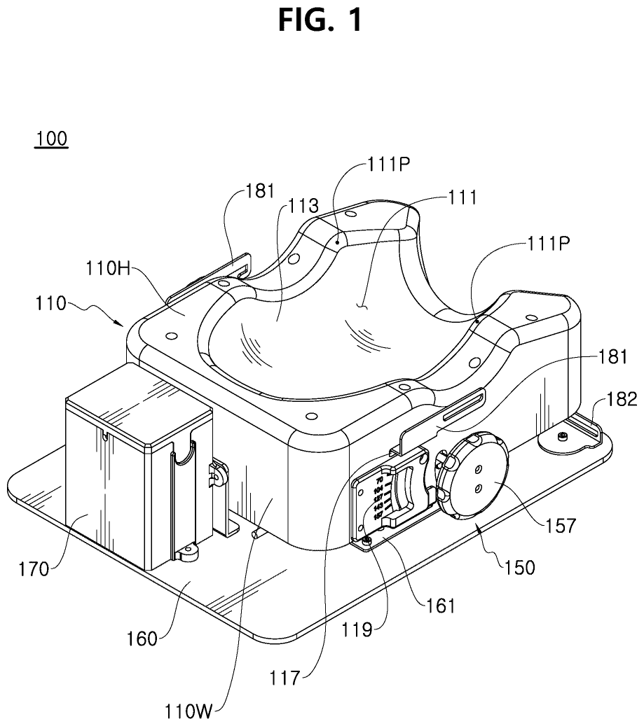

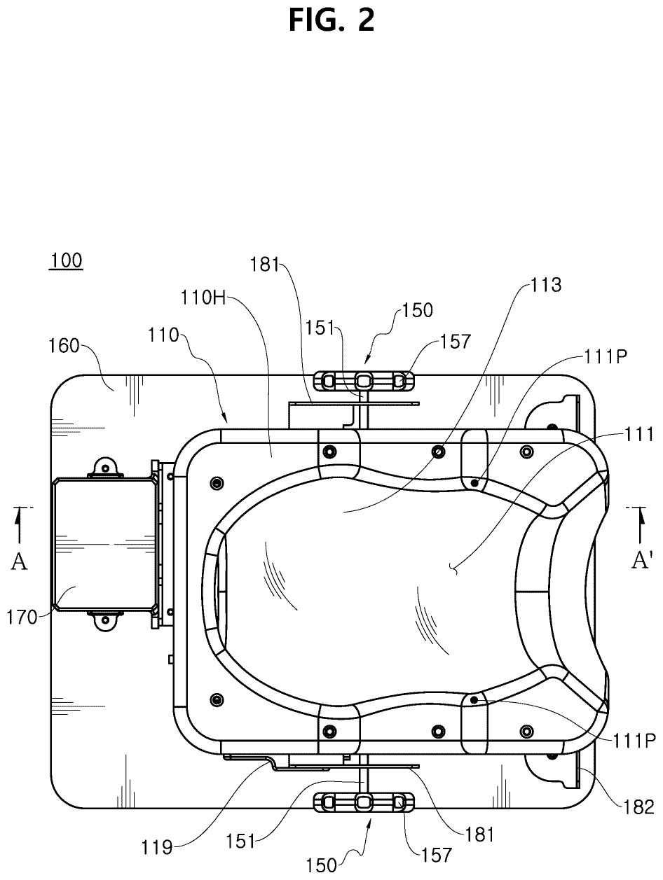

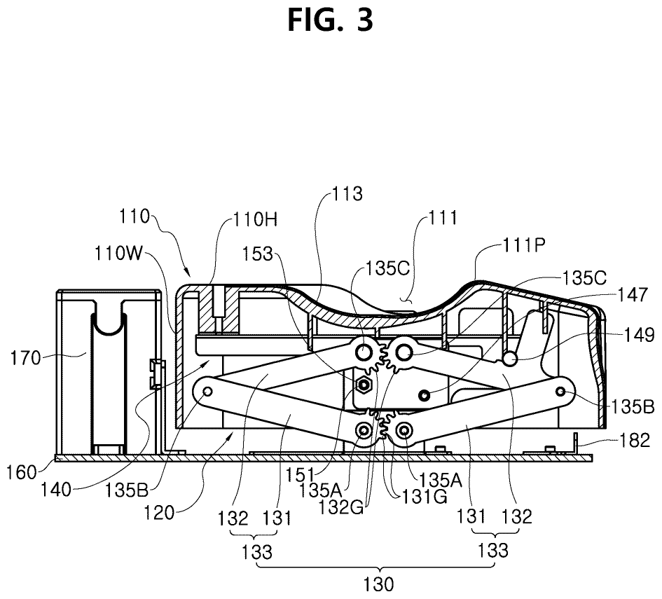

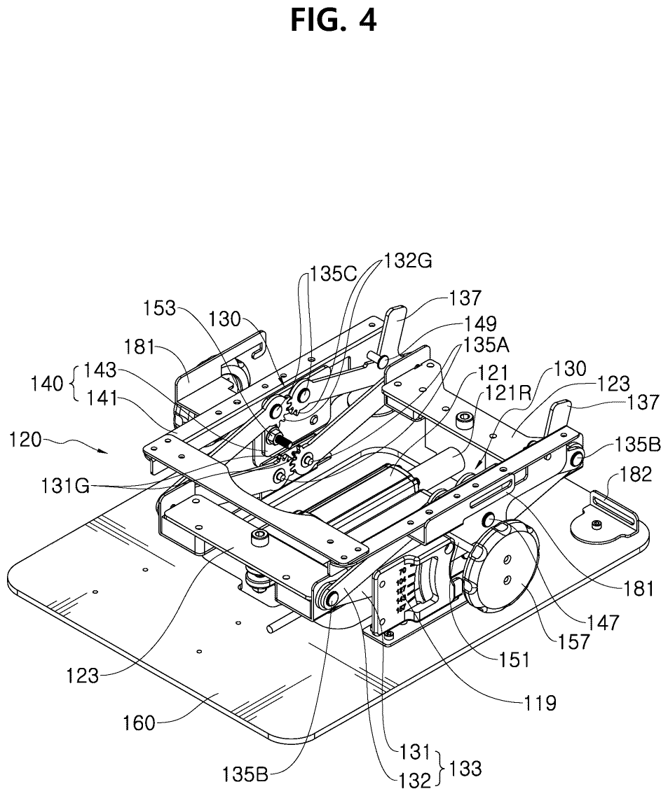

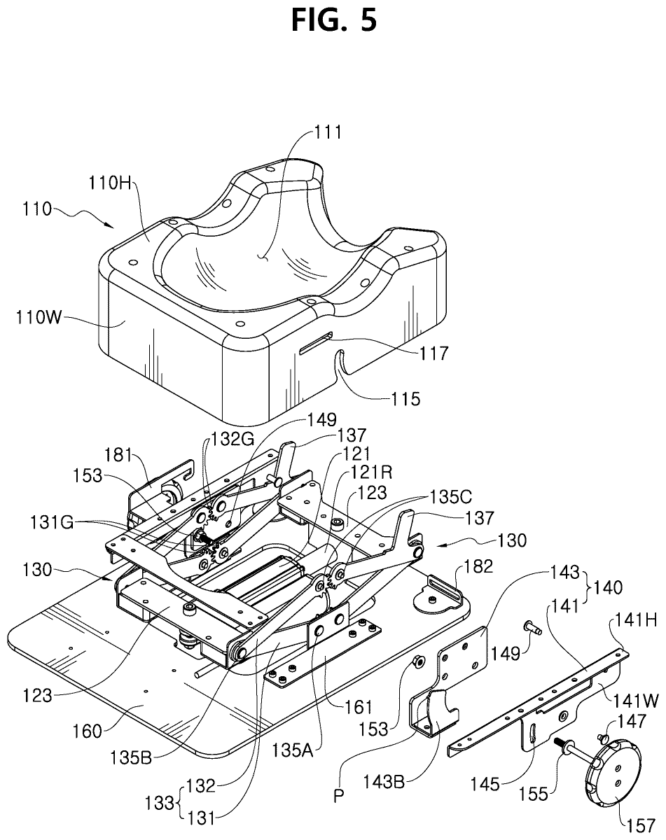

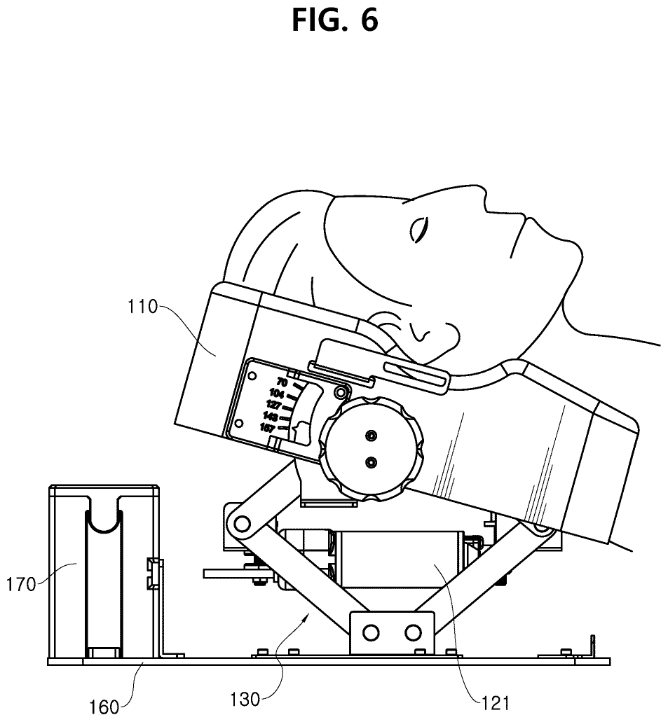

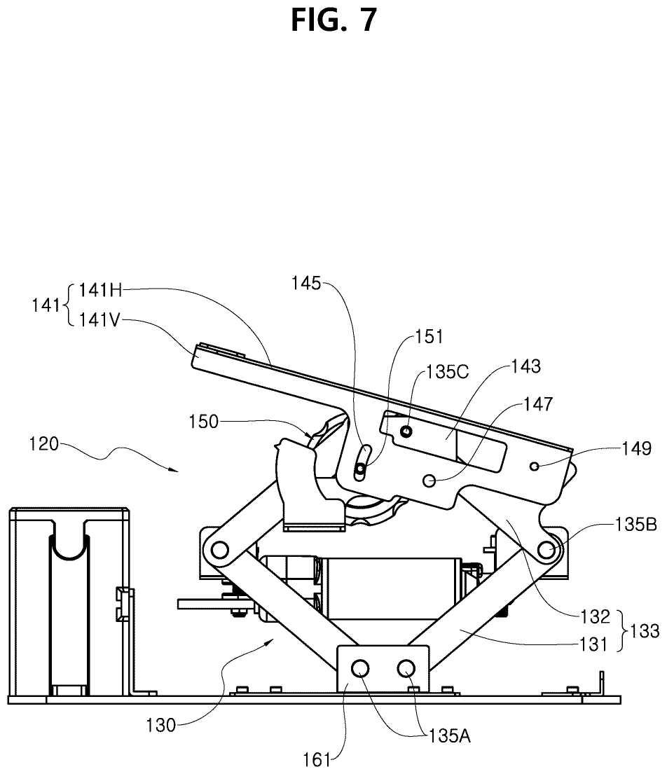

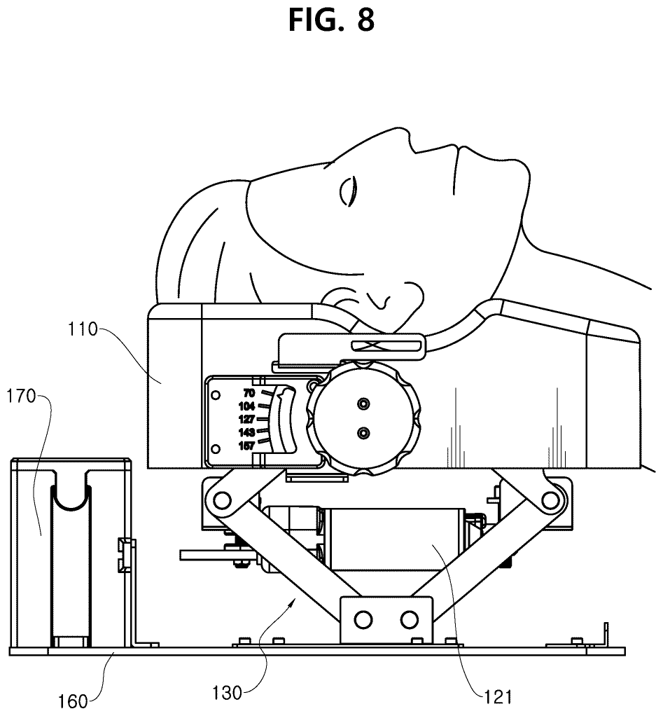

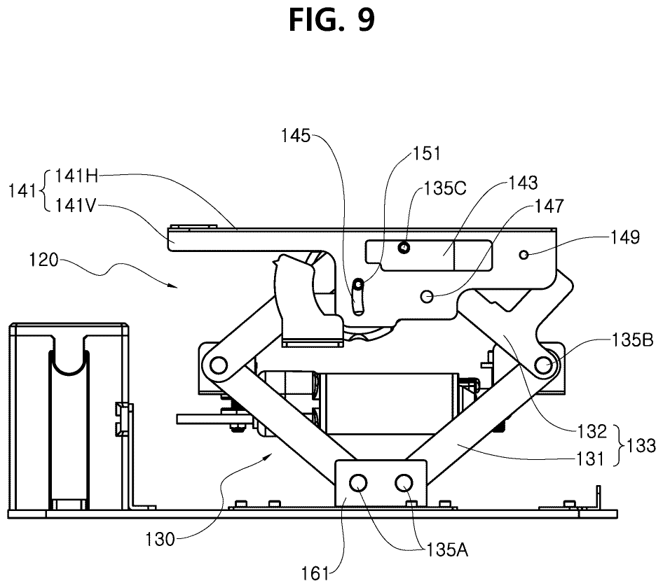

In the drawings, FIG. 1 is a perspective view of a head-up apparatus for cardiopulmonary resuscitation according to the present invention. FIG. 2 is a plan view of the head-up apparatus shown in FIG. 1. FIG. 3 is a longitudinal cross-sectional view of the head-up apparatus shown in FIG. 2. FIG. 4 is a perspective view of an operation unit when a head cover is removed from the head-up apparatus shown in FIG. 1. FIG. 5 is an exploded perspective view of the operation unit shown in FIG. 4. FIG. 6 is a front view of the head-up apparatus when a user's head is raised. FIG. 7 is a front view of the operation unit of the head-up apparatus shown in FIG. 6. FIG. 8 is a front view of the head-up apparatus when the head cover is tilted from the state of FIG. 6. FIG. 9 is a front view of the operation unit of the head-up apparatus in the state of FIG. 8.

As shown in FIG. 1, a head-up apparatus 100 for cardiopulmonary resuscitation includes a head cover 110 that surrounds a back of a head, a neck, and both jaws of a user, an operation unit 120 that supports the head cover 110, moves the head cover 110 in an up-down direction, and tilts the head cover 110 that has moved upward, a base plate 160 on which the operation unit 120 is mounted, and a power supply unit 170 that supplies power to the operation unit 120.

When the user's head is seated on the head cover 110 and the operation unit 120 is operated, the head cover 110 moves upward and the user's head is positioned higher than the heart. This can increase cerebral perfusion pressure and cerebral blood flow as the user's head is positioned higher than the heart. However, when the user's head is raised upwards in the supine position, the user's neck may be bent and the airway or blood vessels may be closed. That is, when the head cover 110 is tilted upward while the top of the user's head is positioned higher than the chin, the user's neck may be bent and the airway or blood vessels may be closed. In this case, by pressing the front end of the head cover 110 to lower the top of the user's head, the tilted head cover 110 may be horizontally tilted to make the top of the user's head and the chin on the same level, thereby opening the airway or the blood vessels of the user.

Thus, the head-up apparatus 100 for cardiopulmonary resuscitation according to the present invention may open the airway and blood vessels by placing the user's head horizontally and place the user's head higher than the heart. By performing cardiopulmonary resuscitation in such a state, the cerebral perfusion pressure and the cerebral blood flow may be increased while preventing closure of the airway or blood vessels.

The head-up apparatus for cardiopulmonary resuscitation configured as described above will be described in detail below.

As shown in FIGS. 1 to 3, the head cover 110 of the head-up apparatus 100 for cardiopulmonary resuscitation includes a groove 111 formed in an upper surface 110H of the head cover 110 so as to surround the back of the head, the neck, and both jaws of the user in the supine position. A cushion unit 113 made of silicone is attached to the inside of the groove 111 to protect the user's head seated on the groove 111.

At the edges of the groove 111 of the head cover 110, protrusions 111P in contact with both jaws are formed. The protrusions 111P are in contact with the jaws when the user's head is seated on the inside of the groove 111 to form an air passage between the user's head and the groove 111. When the front end of the head cover 110, which is on the top of the user's head, is pressed and tilted, the protrusions 111P may push up the jaws of the user to maintain the horizontal state of the head cover 110 as shown in FIG. 8, thereby opening the airway and blood vessels of the user. The protrusions 111P may also be attached to the cushion unit 113 to prevent direct contact with the head cover 110 made of a plastic material, thereby minimizing the pressure when the protrusions 111P push up the jaws.

The head cover 110 includes the upper surface 110H on which the groove 111 is formed, and a sidewall 110W extending downward from an edge of the upper surface 110H. Curved tilting long holes 115 and first band bracket holes 117 through which first band brackets 181 fixing a band (not shown) used to fix the user's head pass are formed in both sidewalls 110W of the head cover 110 in a longitudinal direction. The tilting long holes 115 and the first band bracket holes 117 will be described in detail below.

As shown in FIGS. 4 and 5, the operation unit 120 is positioned inside the sidewall 110W formed along the circumference of the head cover 110, and the operation unit 120 is mounted on the base plate 160. The power supply unit 170 is preferably mounted on one side of the base plate 160 to supply power necessary for operating the operation unit 120 while positioned in front of the head cover 110.

The operation unit 120 for moving the head cover 110 in the up-down direction will be described in detail below.

As shown in FIGS. 4 to 5, the operation unit 120 is mounted on the upper surface of the base plate 160, power is supplied from the power supply unit 170 mounted on the base plate 160 to operate the operation unit 120, and the head cover 110 fixed to the upper end of the operation unit 120 moves in the up-down direction according to the operation of the operation unit 120.

The operation unit 120 includes a motor cylinder 121 that is a driving unit of which stroke expands and contracts as the rod 121R moves forward and backward, a link unit 130 that switches the expansion and contraction direction of the motor cylinder 121 to expansion and contraction in the up-down direction, a head cover frame 140 attached to an upper end of the link unit 130, and a tilting lock unit 150 that locks the head cover frame 140 positioned horizontally by tilting the head cover 110.

The motor cylinder 121 is positioned in the longitudinal direction in the middle of the width of the base plate 160 such that the expansion and contraction direction thereof is positioned in the longitudinal direction of the base plate 160.

Two vertically-positioned connecting bars 123 are respectively mounted on both ends of the motor cylinder 121, and the link units 130 are mounted on both ends of each connecting bar 123. The pair of link units 130 are located on the left side and the right side of the motor cylinder 121 and are connected to the two connecting bars 123.

Therefore, the pair of link units 130 on both sides are equally interlocked with each other in accordance with the stroke expansion and contraction of the motor cylinder

More specifically, fixed brackets 161 are fixed to the base plate 160 on the outside of the pair of link units 130 respectively located on both sides. Each link unit 130 includes a first link 131 having one end hinged to the fixed bracket 161 and a gear unit 131G formed around the one end of the first link 131, and a second link 132 having one end hinged to the other end of the first link 131 and the other end hinged to the head cover frame 140 and a gear unit 132G formed around the other end of the second link 132, where link assemblies 133 in which the first link 131 is coupled to the second link 132 are symmetrically arranged to form one link unit 130.

A hinge which connects one end of the first link 131 to the fixed bracket 161 is referred to as a first hinge 135A, a hinge which connects the first link 131 to the second link 132 and is fixed to the connecting bar 123 is referred to as a second hinge 135B, and a hinge which connects the other end of the second link 132 to the head cover frame 140 is referred to as a third hinge 135C.

In addition, the gear unit 131G formed in the first link 131 is engaged with the gear unit 131G of the counterpart first link 131 which is symmetrical thereto in the front-rear direction. The gear unit 132G formed in the second link 132 is engaged with the gear unit 132G of the counterpart second link 132 which is symmetrical thereto in the front-rear direction.

Therefore, when the stroke of the motor cylinder 121 expands, the first link 131 and the second link 132 pivot in a direction in which the angle between the first and second links 131 and 132 is narrowed while the connecting bar 123 moves, and thus the head cover frame 140 is moved downward.

When the stroke of the motor cylinder 121 contracts, the head cover frame 140 moves upward while the first link 131 and the second link 132 pivot in a direction in which the angle between the first and second links 131 and 132 is widened while the connecting bar 123 moves.

As the connecting bar 123 moves in the front-rear direction according to the stroke of the motor cylinder 121, the opposite link units 130 on the left and right sides, and the engaged first links 131 and the engaged second links 132 are interlocked with each other.

The head cover frame 140 is largely divided into an upper frame 141 and a vertical frame 143 located on the inner surface of the upper frame 141.

The upper frame 141, which has a structure bent at a right angle, includes a horizontal surface 141H fixed to the head cover 110, and a vertical surface 141V where a curved long hole 145 for tilting is formed and a tilting shaft 147 is mounted. The vertical frame 143 faces the vertical surface 141V of the upper frame 141. The mutually engaged third hinges 135C of the second link 132, the tilting shaft 147, and the tilting lock unit 150 are mounted on the vertical frame 143.

The vertical frame 143 is connected to the vertical surface 141V of the upper frame 141 by the tilting shaft 147 to move along the upper frame 141 in the up-down direction.

The tilting lock unit 150 includes a locking bolt 151 mounted to the vertical frame 143 through the curved long hole 145 formed in the vertical surface 141V of the upper frame 141, a nut 153 welded and fixed to the inside of the vertical frame 143 and screwed to the locking bolt 151 passing through the vertical frame 141, a locking flange 155 formed in the middle of the length of the locking bolt 151 and configured to press the vertical surface 141V of the upper frame 141 to fix the vertical surface 141V and the vertical frame 143 and fix the horizontally tilted upper frame 141, and a handle 157 fixed to an end of the locking bolt 151. The locking bolt 151 extends outward through the curved tilting long hole 115 formed in the sidewall 110W of the head cover 110, and the handle 157 is fixed to the end of the outwardly-extending locking bolt 151.

Therefore, when the stroke of the motor cylinder 121 contracts and the angle between the first link 131 and the second link 132 widens, the head cover 110 fixed to the upper frame 141 moves upward.

At this time, as shown in FIG. 6, depending on the user's characteristics, such as a height, the head cover 110 may be tilted to position the user's head higher than the chin while the user's neck is bent forward. In this case, the airway or blood vessels may be closed.

As such, when the user's neck is bent in the process of lifting the user's head, the tilted head cover 110 should be horizontally tilted by pressing the front end of the head cover 110 to lower the top of user's head, thereby opening the user's airway or blood vessels.

When the medical staff presses the front end of the head cover 110, the upper frame 141 inclined with respect to the tilting shaft 147 becomes horizontal as shown in FIGS. 8 and 9. At this time, the vertical frame 143 maintains the original vertical state regardless of the tilt of the upper frame 141 as the two third hinges 135C are mounted to and the locking bolt 151 passes through the vertical frame 143. As the upper frame 141 is tilted horizontally, the protrusions 111P push up the user's jaws and position the user's top of the head and jaws horizontally to open the airway and blood vessels.

The locking bolt 151 is fastened to the nut 153 through the vertical frame 143 and passes through the curved long hole 145 formed in the vertical surface 141V of the upper frame 141 and the curved tilting long holes 115 formed in the sidewall of the head cover 110 to tilt the upper frame 141. The locking bolt 151 moves relatively along the long holes 115 and 145.

As described above, when the locking bolt 151 is tightened by rotating the handle 157 located outside the head cover 110 while the upper frame 141 is tilted horizontally, the vertical frame 143 and the vertical surface 141V of the upper frame 141 are pressed against each other to lock the upper frame 141, which rotates with respect to the tilting shaft 147.

As the upper frame 141 is locked horizontally, the user's top of the head to the neck are maintained in the horizontal state to open the airway or blood vessels. As the upper frame 141 is moved upward, the user's head is positioned higher than the heart.

Thus, it is possible to increase cerebral perfusion pressure and cerebral blood flow with the airway or blood vessels open, thereby improving the neurological prognosis of the user.

Hereinafter, other configurations of the head-up apparatus 100 for cardiopulmonary resuscitation according to the present invention will be described in detail.

As shown in FIG. 5, a stopper 149 is fixed to the vertical surface 141V of the upper frame 141 so as to face the inside of the operation unit 120. As the upper frame 141 rotates with respect to the tilting shaft 147, the stopper 149 also moves in the up-down direction with respect to the tilting shaft 147. When the upper frame 141 is inclined, the stopper 149 moves downward to interfere with the upper surface of the second link 132, thereby preventing the upper frame 141 from being inclined at a steeper tilt. This prevents the user's neck from being excessively bent.

In this state, when the upper frame 141 is horizontally positioned by pressing the front end of the head cover 110, the stopper 149 moves upward to be further away from the second link 132.

A guide 137 for guiding movement of the stopper 149 is preferably formed upward on the upper surface of the second link 132 as shown in FIG. 5.

In addition, a display unit 119, which displays the angle of the head cover 110 or the height from the bottom of the groove 111 of the head cover 110 to the base plate 160 with a number, a letter, or the like, is mounted on the outside of the sidewall 110W of the head cover 110. One end of a guide piece 143B on which a guide P is formed is fixed to the vertical frame 143 and extends outward from the head cover 110 and then the guide P is positioned toward the display unit 119.

When the head cover 110 is inclined while moving upward or is tilted horizontally by the medical staff, the upper frame 141 rotates with respect to the tilting shaft 147 along the head cover 110. However, since the vertical frame 143 moves only up and down, the guide P is located in a fixed position and the point indicated by the guide P changes as the display unit 119 rotates relatively along the head cover 110.

Accordingly, a point at which the motor cylinder 121 maximally expands becomes a lower end point of the head cover 110, and a point at which the motor cylinder 121 maximally contracts becomes an upper end point of the head cover 110. As such, when the head cover 110 moves up and down without being tilted, the upper frame 141 and the vertical frame 143 also move up and down together and thus the point of the display unit 119 indicated by the guide P does not change. However, when the head cover 110 is inclined, only the upper frame 141 rotates with respect to the tilting shaft 147 and thus the tilt of the display unit 119 also changes, thereby changing the point of the displayed unit 119 indicated by the guide P.

As described above, the display unit 119 may display the angle of the head cover 110 on the display unit 119 according to the characteristics of the head-up apparatus 100 that operates according to such a mechanism or may display the height from the bottom of the groove 111 of the head cover 110 to the base plate 160 with a number, a letter, or the like.

The band mounted on the head cover 110 fixes the user's head to prevent the head from shaking during cardiopulmonary resuscitation while the user's head is seated on the groove 111 of the head cover 110. To this end, a first band bracket 181 is fixed to the horizontal surface 141H of the upper frame 141, and the first band bracket 181 extends to the outside of the sidewall 110 W of the head cover 110 through the first band bracket hole 117 formed in the sidewall 110W of the head cover 110. One end of the band is hooked onto the first band bracket 181 and the other end thereof is hooked onto the opposite first band bracket 181, thereby pressing and fixing the user's head seated on the groove 111 of the head cover 110.

At this time, a Velcro tape is preferably attached to the band to make the ends of the band easily detachable from each other.

In addition, a second band bracket 182 may be mounted on a rear end of the base plate 160, and one end of the band may be fixed to the second band bracket 182, so as to cover the shoulder of the user.

Although a battery is illustrated as the power supply unit 170 of the head-up apparatus 100 for cardiopulmonary resuscitation according to the present invention described above, the operation unit 120 may be driven by receiving an external power supply through an external power cable, instead of the battery.

In an embodiment of the head-up apparatus described above, it is shown that the head cover 110 is mounted on the upper frame 141 of the head cover frame 140. In this case, since the user's head needs to be accommodated in the groove 111 of the head cover 110, it is difficult to use the head-up apparatus according to the present invention when the user's head is larger than the groove 111.

Although not shown in the drawings, the head cover may be divided into a left head cover and a right head cover, and the left head cover and the right head cover may be configured to be movable in a direction where the left head cover and the right head cover are further away or closer to be in contact with each other.

In this case, a sliding rail that can slide in the left-right direction is mounted between the divided head cover and the horizontal surface of the upper frame so that the left head cover and the right head cover can move further away or closer to be in contact with each other along the sliding rail, and an actuator that can extend and contract the left head cover and the right head cover is mounted. The expansion and contraction of the actuator then allows the left head cover and the right head cover to be further away or closer to be in contact with each other along the sliding rail. By moving the left head cover and the right head cover in such a direction away from each other, the groove formed in the head cover can be expanded in the left-right direction to widen the range of the head size that can be accommodated therein.

The actuator may be the motor cylinder described above. Alternatively, the left screw block may be fixed to one of the left head cover and the right head cover, and the right screw block may be secured to the other one of the left head cover and the right head cover. After fastening the bolt having the left screw formed on one side and the right screw formed on the other side, the bolt may be rotated by a motor or manually to move the left head cover and the right head cover so as to be further away or closer to be in contact with each other.

According to an exemplary embodiment, the apparatus may further include a cerebral blood flow measuring device (not shown), for example, a near-infrared spectroscopy device, which measures the cerebral blood flow of the user according to the height of the user's head, so as to be in contact with the back side of the user's head. In addition, the driving unit may be controlled based on the cerebral blood flow of the cerebral blood flow measuring device. To this end, a control unit (not shown) may be further included.

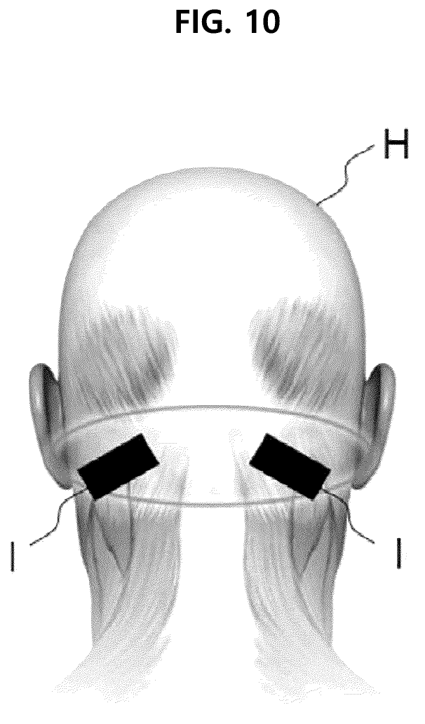

FIG. 10 is a schematic view of the cerebral blood flow measuring device attached to the back of the head.

As shown in FIG. 10, a cerebral blood flow analyzing device may analyze the cerebral blood flow signal received from a test patch I mounted on the user head H to analyze the real time cerebral blood flow of the user. In this case, the cerebral blood flow analyzing device may analyze the cerebral blood flow using near-infrared spectroscopy (NIRS). However, the embodiments are not limited thereto. The cerebral blood flow analyzing device may measure the cerebral blood flow of the user through any other suitable method according to the embodiments. In addition, the cerebral blood flow analyzing device may use a micro light emitted diode (LED) to obtain an improved cerebral blood flow signal of the user, but the embodiments are not necessarily limited thereto.

In a non-limiting example, the test patch may be attached to the user's skin to obtain the cerebral blood flow signal. For example, the test patch may be attached to the user's forehead or may be attached to the back of the head of the user. Due to the weight of the user's head, the test patch is preferably attached to the back of the head of the user, rather than the user's forehead, to provide a better attachment environment, thereby more effectively obtaining the cerebral blood flow signal of the user.

The head-up apparatus 100 for cardiopulmonary resuscitation may control the driving unit to adjust the height of the user's head, according to the operation mode of the control unit, and thus measure the real time cerebral blood flow of the user.

The target cerebral blood flow may be 1.15 times the real-time cerebral blood flow of the user, for example, while the angle between the back and the head of the user is 0 degrees. However, the embodiments are not limited thereto, and the target cerebral blood flow may be variously changed according to the embodiments.

More specifically, it is possible to measure the real-time cerebral blood flow while the height of the head of the user is positioned arbitrarily according to the operation mode of the control unit.

Next, a height satisfying a predetermined condition, according to the operation mode of the control unit, may be searched for. For example, it is possible to search for a height that satisfies a predetermined condition according to the first mode or a predetermined condition according to the second mode of the control unit.

Then, the driving of the driving unit can be stopped at a height satisfying a predetermined condition.

In the first mode, the control unit may gradually increase the height of the head of the user. For example, the control unit may gradually increase the height from a minimum value in a preset range. However, the embodiment is not limited thereto, and the control unit may gradually increase from another value.

The control unit may then measure the user's real-time cerebral blood flow at a gradually increasing height. The control unit may then determine whether the real-time cerebral blood flow of the user has a value greater than the above-described target cerebral blood flow. When the real-time cerebral blood flow of the user has a value smaller than the above-described target cerebral blood flow, the control unit may control the driving unit to further increase the height of the head. When the real-time cerebral blood flow of the user has a value greater than the above-described target cerebral blood flow, the control unit may control the driving unit to fix the height of the user's head.

In the second mode, the control unit may adjust the height of the user's head to correspond to a preset height. Then, the control unit may measure the real-time cerebral blood flow of the user at a plurality of preset points. Accordingly, the control unit may search for the height at which the increase in the cerebral blood flow is the greatest among the real-time cerebral blood flow of the user at each of a plurality of height points. Then, the control unit may control the driving unit to be fixed at the height at which the increase in the cerebral blood flow is the greatest.

1. A head-up apparatus comprising:
a head cover having a groove formed therein to accommodate a head of a user;
an operation unit that supports the head cover, moves the head cover in an up-down direction, and tilts the tilted head cover horizontally;
a driving unit that drives the operation unit so that the head cover moves in the up-down direction; and
a locking unit for locking the head cover horizontally.

2. The head-up apparatus of claim 1, further comprising a cushion unit fixed to the inside of the groove.

3. The head-up apparatus of claim 2, wherein the groove is formed on an upper surface of the head cover and surrounds the back of the head and the neck of the user, protrusions in contact with jaws of the user are formed at edges of the groove, and the cushion unit covers the protrusions.

4. The head-up apparatus of claim 3, wherein a sidewall is formed downward from an edge of the upper surface of the head cover, the operation unit is located inside the sidewall of the head cover, and the operation unit is fixed to a base plate located below the head cover.

5. The head-up apparatus of claim 1, wherein the driving unit expands and contracts in a longitudinal direction thereof, and the operation unit is connected to the driving unit to move the head cover in the up-down direction, according to expansion and contraction of the driving unit.

6. The head-up apparatus of claim 5, wherein the operation unit comprises:
an upper frame including a horizontal surface where the head cover is fixed and a vertical surface bent downward from the horizontal surface;
a vertical frame located on a side of the vertical surface of the upper frame and connected thereto by a tilting shaft to be relatively rotatable;
a base plate positioned below the head cover; and
a plurality of link units having one end hinged to the base plate and the other end hinged to the vertical frame, wherein the link units are connected to the driving unit to move the vertical frame and the upper frame upward or downward according to expansion and contraction of the driving unit.

7. The head-up apparatus of claim 6, wherein the link unit has a structure in which two link assemblies are symmetrical to each other, each of the link assemblies includes a first link having one end coupled to the base plate by a first hinge and pivoting in the up-down direction, and a second link having one end coupled to the other end of the first link by a second hinge and the other end coupled to the vertical frame by a third hinge, and a pair of the link units face each other with the driving unit interposed therebetween.

8. The head-up apparatus of claim 7, wherein connecting bars fixed to both ends of the driving unit are each fixed, and the second hinge connecting the first link to the second link is attached to both ends of each connecting bar.

9. The head-up apparatus of claim 7, wherein a gear unit is formed at one end of the first link to be engaged with a gear unit of another first link located symmetrically with the first link, and a gear unit is formed at the other end of the second link to be engaged with a gear unit of another second link located symmetrically with the second link.

10. The head-up apparatus of claim 7, wherein a stopper is mounted on the upper frame, and the stopper interferes with the second link while the upper frame is tilted, thereby limiting the tilt of the upper frame.

11. The head-up apparatus of claim 10, wherein the second link interfering with the stopper is provided with a guide for guiding a movement direction of the stopper according to a change in tilt of the upper frame.

12. The head-up apparatus of claim 6, wherein the locking unit comprises:
a locking bolt penetrating the vertical frame and a vertical surface of the upper frame;
a nut fixed to one of the vertical frame and the vertical surface of the upper frame and screwed with the locking bolt;
a locking flange formed in the middle of a length of the locking bolt and configured to press the other of the vertical frame and the vertical surface of the upper frame by rotation of the locking bolt to increase friction between the vertical frame and the vertical surface of the upper frame to limit tilting of the upper frame; and
a handle fixed to an end of the locking bolt.

13. The head-up apparatus of claim 12, wherein a curved long hole is formed on the other side of the vertical surface of the upper frame and the vertical frame pressed by the locking flange to enable the locking bolt to penetrate the curved long hole and the upper frame to be tilted.

14. The head-up apparatus of claim 6, wherein a display unit indicating a tilting angle of the upper frame or a height of the head cover is mounted on an outer surface of the head cover, a guide piece extending outward of the head cover and facing the display unit is fixed to the vertical frame, and a guide of the guide piece points to a point of the display unit that moves according to a tilted angle or a vertical movement of the head cover.

15. The head-up apparatus of claim 6, further comprising a first band bracket mounted on the upper frame and extending outward of the head cover, and a second band bracket mounted on a rear end of the base plate, wherein a band mounted on the first band bracket surrounds and fixes the user's head located in the groove of the head cover, and a band mounted on the second band bracket surrounds the shoulder of the user.

16. The head-up apparatus of claim 5, wherein the head cover is symmetrically split to a left head cover and a right head cover so that the left head cover and the right head cover are movable to be further away or closer to be in contact with each other.

17. The head-up apparatus of claim 16, wherein the operation unit comprises:
a sliding rail that connects the left head cover to the right head cover and is mounted such that the left head cover and right head cover slide freely in the left-right direction;
an actuator coupled to the left head cover and the right head cover to move the left head cover and right head cover to be further away or closer to be in contact with each other;
an upper frame including a horizontal surface on which the sliding rail is mounted and a vertical surface bent downward from the horizontal surface;
a vertical frame located on a side of the vertical surface of the upper frame and connected thereto by a tilting shaft to be relatively rotatable;
a base plate positioned below the head cover; and
a link unit having one end hinged to the base plate and the other end hinged to the vertical frame, the link unit being connected to the driving unit to move the vertical frame and the upper frame upward or downward according to expansion and contraction of the driving unit.

18. The head-up apparatus of claim 16, wherein the actuator comprises:
a left screw block fixed to one of the left head cover and the right head cover;
a right screw block fixed to the other of the left head cover and the right head cover; and
a bolt having a left screw formed on one side and a right screw formed on the other side, the bolt being fastened to the left screw block and the right screw block and moving the left screw block and the right screw block to be further away or closer to be in contact with each other according to rotation.

19. The head-up apparatus of claim 1, wherein the apparatus further comprises a cerebral blood flow measuring device for measuring the cerebral blood flow of the user according to the height of the user's head, and the apparatus controls the driving unit based on the cerebral blood flow of the cerebral blood flow measuring device.

20. A method for controlling a head-up apparatus comprising a head cover having a groove formed therein to accommodate a head of a user, an operation unit configured to support the head cover, move the head cover in an up-down direction, and tilt the tilted head cover horizontally, a driving unit configured to drive the operation unit to move the head cover in the up-down direction, and a locking unit configured to lock the head cover horizontally, the method comprising:
driving the driving unit while the user's head is seated on the groove;
moving the head cover upward to be tilted while the operation unit moves the head cover upward by the driving of the driving unit so that a front end of the head cover that is close to the top of the head of the user is positioned higher than a rear end of the head cover that is close to the chin of the user;
tilting the head cover horizontally to open the user's airway and blood vessels; and
tilting and locking the head cover while the head cover is tilted horizontally.
